(19) United States
(12) Patent Application Publication
(10) Pub. No.: US 2009/0250160 A1
(43) Pub. Date: Oct. 8, 2009

(54) METHOD OF FABRICATING OPTICAL FUNCTIONAL ELEMENT

(75) Inventors: Shinnosuke Soda, Tokyo (JP); Yukihisa Yoshida, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/401,203

(22) Filed: Mar. 10, 2009

(30) Foreign Application Priority Data
Apr. 8, 2008 (JP) 2008-100406
Nov. 20, 2008 (JP) 2008-296422

(51) Int. Cl. B32B 37/00

(52) U.S. Cl. 156/250

(57) ABSTRACT

A comb-teeth electrode, a frame electrode, and an inter-electrode wire are formed on a first major surface of a substrate made of a ferroelectric material. A back-face electrode is formed on a second major surface of the substrate. A periodically-poled structure is formed by applying a voltage between the frame electrode and the back-face electrode. A region equivalent to the periodically-poled structure is cut from the substrate thereby fabricating an optical functional element. The inter-electrode wire is formed on an insulating layer that is formed on the substrate.

### BACKGROUND OF THE INVENTION

1. Field of the Invention

The present invention relates to a method of fabricating an optical functional element having a periodically-polled structure on a substrate made of a ferroelectric material.

2. Description of the Related Art

A domain inverted region can be formed on a desired part of a substrate made of a ferroelectric material by applying an electric field to the substrate with an electron beam or electrodes. This technology can be used to fabricate various optical functional elements, for example, optical wavelength converter elements. A typical high-efficient optical wavelength converter element is fabricated, for example, by forming a periodically-poled structure in which the domain inverted region and the domain non-inverted region are formed alternately based on the nonlinear optical-crystal substrate made of a ferroelectric material. In the optical wavelength converter element, a phase of a wave that is input to the nonlinear optical-crystal substrate is quasi-matched to a phase of a second harmonic wave that is generated due to nonlinear optical effects. With this method, an optical wavelength converter element having high conversion efficiency can be fabricated.

Japanese Patent Application Laid-open No. H4-19719 discloses a method of forming the periodically-poled structure based on a lithium niobate (LiNbO₃) crystal substrate that is cut along a Z surface. More particularly, a comb-teeth electrode is formed on the +Z surface of the crystal substrate and a plane electrode is formed on the −Z surface of the crystal substrate. The domain inverted region is then grown in the direction of the Z axis in a region on which the comb-teeth electrode is formed by applying a predetermined voltage between the comb-teeth electrode and the plane electrode. Thus, the periodically-poled structure is formed.

However, when a voltage is applied between the comb-teeth electrode and the plane electrode, a phenomenon appears that a high electric field is produced on an end area of a pattern of the comb-teeth-electrode due to fringe effects. Due to this phenomenon, the polarization reverse excessively progresses in a region that is closer to the end area of the pattern of the comb-teeth electrode, so that even the polarization in a region on which the comb-teeth electrode is not formed is reversed (hereinafter, this phenomenon is called “excess reversal”). As a result, the non-uniform periodically-poled structure in which a ratio between the domain inverted region and the domain non-inverted region at the end area differs from a ratio at the center area is disadvantageously formed.

It has been known that wavelength conversion efficiency of an optical wavelength converter element is a function of a nonlinear optical coefficient of a material of the substrate, and the conversion efficiency increases as the ratio of a width of the domain inverted region to a width of the domain non-inverted region is closer to 50:50. Therefore, the wavelength conversion efficiency of the wavelength converter element that is fabricated with the method disclosed in Japanese Patent Application Laid-open No. H4-19719 is low; because, the ratio of the domain inverted region to the domain non-inverted region is not uniform. To improve the conversion efficiency, even if a region having the ratio of the domain inverted region to the domain non-inverted region of 50:50 is formed on the center area of the comb-teeth electrode by adjusting polarization reversal conditions, the fabrication costs increases remarkably because the efficient use area per substrate is too small. Therefore, this method was not suitable for practical applications.

To suppress occurrence of the high efficient field due to the fringe effects, several approaches have been disclosed. For example, Japanese Patent Application Laid-open No. H7-261212 teaches to use a smaller ground-side electrode than an electrode from which the electric field is applied. Japanese Patent Application Laid-open No. 2003-270687 teaches to arrange a frame electrode surrounding an outer circumference of the comb-teeth electrode such that a width of the frame electrode is equal to or larger than a width of each of comb-teeth members of the comb-teeth electrode.

Although the fringe effects can be suppressed to a greater extent by using the technology that is disclosed in Japanese Patent Application Laid-open No. H7-261212 as compared to the technology that is disclosed in Japanese Patent Application Laid-open No. H4-19719, the occurrence of the high electric field due to the fringe effects cannot be eliminated perfectly. Moreover, while use of a smaller electrode as one of the pair of the electrodes makes it possible to shrink the high electric-field area on the other one of the pair of the electrodes occurring on the end area due to the fringe effects, use of a too small electrode can lead to occurrence of a high electric field on the center area. Still moreover, use of a smaller comb-teeth electrode leads to a decrease in the number of elements fabricated from the single substrate, which increases the fabrication costs.

The excess reversal on the end area of the comb-teeth electrode can be suppressed at an early stage of the polarization reversal by using the technology that is disclosed in Japanese Patent Application Laid-open No. 2003-270687. However, in the course of formation of the periodically-poled structure onto an entire area of the comb-teeth electrode, the excess reversal proceeds near the tips of the elongated comb-teeth members. As a result, a non-uniform periodically-poled structure in which the ratio of the width of the domain inverted region to the width of the domain non-inverted region at the tip area differs from the ratio at the center area is disadvantageously formed. Even if the width of the frame electrode is formed wider than the substrate thickness, the non-uniform periodically-poled structure is formed anyway.

### SUMMARY OF THE INVENTION

It is an object of the present invention to at least partially solve the problems in the conventional technology.

According to an aspect of the present invention, there is provided a method of fabricating an optical functional element including forming, on a first major surface of a substrate made of a ferroelectric material, a comb-teeth electrode including a plurality of elongated comb-teeth members, a frame electrode surrounding the comb-teeth electrode, an inter-electrode wire that connects the comb-teeth electrode to the frame electrode, the comb-teeth members being parallel to each other at a predetermined pitch; forming, on a second major surface of the substrate that is opposite to the first major surface, a back-face electrode to cover an entire area of the second major surface; forming a periodically-poled structure by applying a voltage between the frame electrode and the back-face electrode; and cutting out a region equivalent to the periodically-poled structure from the substrate, thereby fabricating the optical functional element, wherein the inter-electrode wire is formed on an insulating layer that is formed on the substrate.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A to 1E are perspective views of a substrate for explaining a process of fabricating an optical functional element according to a first embodiment of the present invention;

FIG. 2 is a cross-sectional view of the substrate taken along an A-A line shown in FIG. 1C;

FIG. 3A is a perspective view of a substrate for explaining an arrangement of electrodes formed on the substrate in the course of formation of a conventional periodically-poled structure;

FIG. 3B is a perspective view of the substrate from which the electrodes shown in FIG. 3A are removed after a polarization is reversed by applying a voltage to the substrate;

FIG. 3C is a cross-sectional view of the substrate taken along a B-B line shown in FIG. 3B;

FIG. 4 is a cross-sectional view of the substrate taken along a C-C line shown in FIG. 1D near an end area of a comb-teeth electrode;

FIG. 5 is a graph of electric-field intensity that is measured when the voltage is applied for polarization reversal in the process of fabricating the optical functional element according to the first embodiment;

FIG. 6 is a graph of the electric-field intensity that is measured when the voltage is applied for the polarization reversal to a substrate having the thickness of 0.25 millimeter (mm);

FIG. 7 is a graph of the electric-field intensity that is measured when the voltage is applied for the polarization reversal to a substrate having the thickness of 1.0 mm;

FIG. 8 is a cross-sectional view of the substrate after the electrodes are patterned according to a third embodiment of the present invention;

FIGS. 9A and 9B are perspective views of different states of the substrate in the course of formation of an electrode pattern by using a method of fabricating an optical functional element according to a fourth embodiment of the present invention; and

FIG. 10 is a cross-sectional view of the substrate taken along a D-D line shown in FIG. 9B.

### DETAILED DESCRIPTION OF THE PREFERRED EMBODIMENTS

Exemplary embodiments of the present invention are described in detail below with reference to the accompanying drawings. Cross-sectional views of the accompanying drawings are schematics merely, and therefore actual relation between layer thickness and layer width and actual ratio between thicknesses of layers are not taken into consideration for drawing of the cross-sectional views.

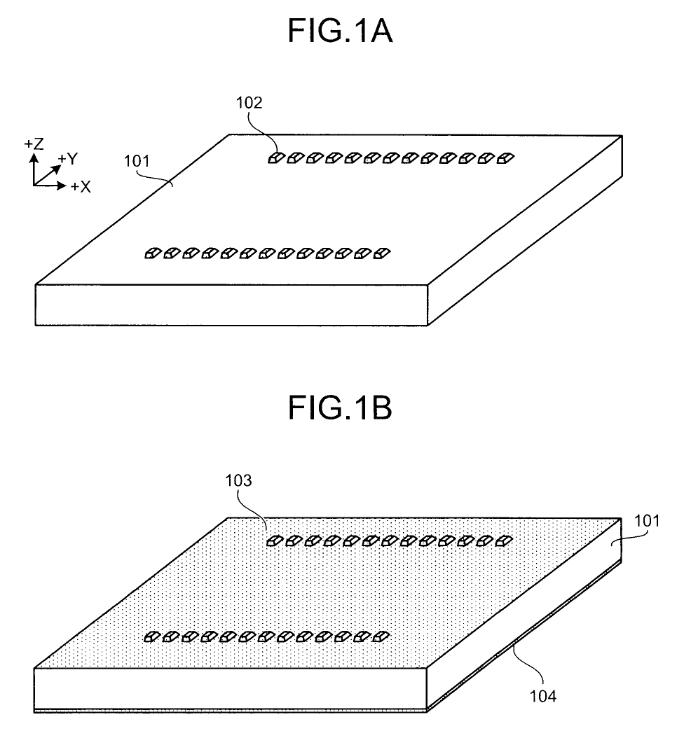

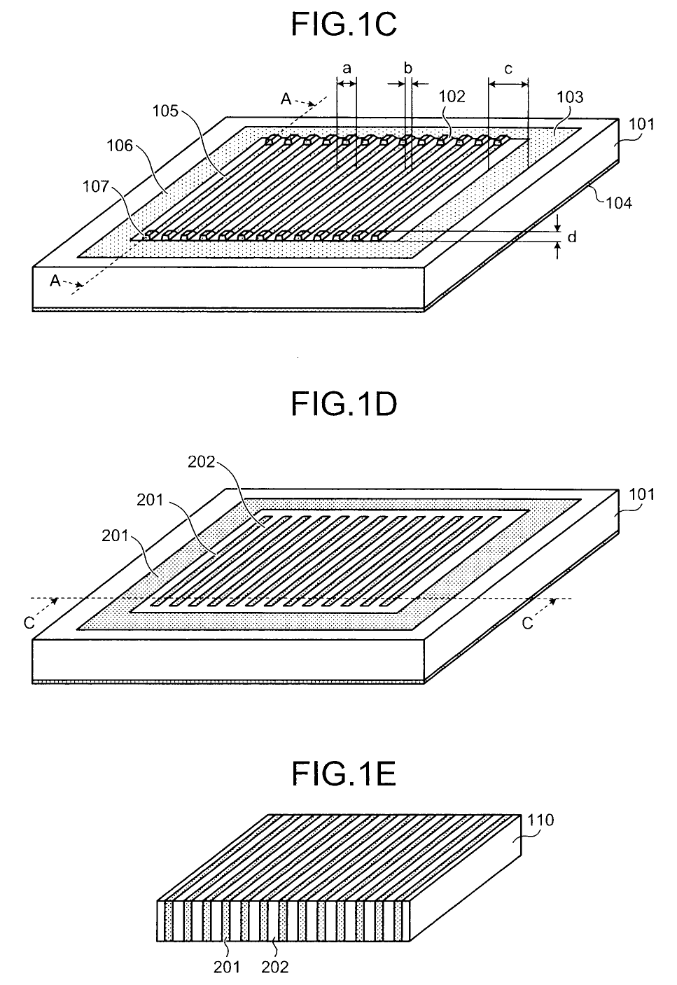

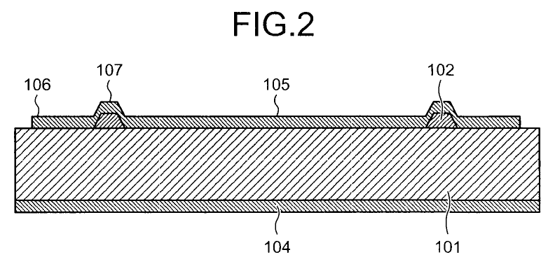

A method of fabricating an optical functional element having a periodically-poled structure on a substrate made of a ferroelectric crystal is described below. FIGS. 1A to 1E are perspective views of a ferroelectric crystal substrate 101 for explaining a process of fabricating an optical functional element according to a first embodiment of the present invention. FIG. 2 is a cross-sectional view of the substrate 101 taken along an A-A line shown in FIG. 1C. Assume now that LiNbO₃ is used as a ferroelectric crystal of the substrate 101. Dimensions and expressions about components in the following embodiments are exemplary, and should not be taken as mandatory. Moreover, it is allowable in the fabricating process to use any nonlinear optical crystal in which a potential reversal occurs by the application of an electric field instead of LiNbO₃.

As shown in FIG. 1A, a photoresist is applied onto a surface of the substrate 101 having the thickness of 0.5 mm to form an insulating layer 102 having the thickness of 3.0 micrometers (μm). The photoresist is, for example, a novolak-based resist. After that, the insulating layer 102 is patterned by using the technique of photolithography so that only a part on which a later-described inter-electrode wire is to be formed is left behind. It is preferable to post-bake the insulating layer 102 that is made of the photoresist to increase electric insulating properties and withstand voltage. The optimal temperature and time for the post baking depends on the type of the photoresist. If, for example, photoresist AZ4330 (product name) produced by AZ Electronic Materials is used, it is preferable to post-bake the insulating layer 102 at 140° C. for five hours or longer. As shown in FIG. 1A, the insulating layer 102 is formed on a +Z surface of the LiNbO₃ substrate 101.

After that, as shown in FIG. 1B, a metal layer 103 having the thickness of 0.5 μm is formed on the +Z surface of the substrate 101 by using a film formation technique such as the spattering, the vapor deposition, and the ion plating. A metal layer having the thickness of 0.5 μm is also formed on a −Z surface of the substrate 101 by using a film formation technique, such as the spattering, the vapor deposition, and the ion plating, thereby forming a back-face electrode 104. A material with which the metal layer 103 and the back-face electrode 104 are formed is preferably Cr, Ti, Ta, Ni, NiCr, etc., from the viewpoint of adhesiveness to the substrate 101. However, if the metal layer 103 and the back-face electrode 104 are formed on the substrate 101 that has been cleaned beforehand with hydrofluoric acid, a low resistance metal such as Au, Ag, Cu, etc., is effective from the viewpoint of decreasing of the electric resistance between comb-teeth members of a comb-teeth electrode, and thereby forming a uniform electric field. Assume now that the metal layer 103 and the back-face electrode 104 are made of Cr.

A photoresist is formed on the metal layer 103 as an etching mask by the photolithography. The metal layer 103 is then patterned by parallel plate plasma etching with CF₄ plasma as an etcher. The etching mask is removed after the etching. As a result, a comb-teeth electrode 105, a frame electrode 106, and inter-electrode wires 107 are formed as shown in FIG. 1C and FIG. 2. The inter-electrode wire 107 is formed on the insulating layer 102. Assume that a pitch of the comb-teeth electrode 105 is 10 μm; a width b of each of comb-teeth members of the comb-teeth electrode 105 is 3 μm; a width c of the frame electrode 106 is 300 μm; and a length d of the inter-electrode wire 107 is 10 μm. To remove only the photoresist as the etching mask from the metal layer 103 with the different photoresist as the insulating layer 102 being un-removed, anisotropic oxygen plasma ashing is effective.

Subsequently, polarization on an electrode-formed surface of the substrate 101 that is fabricated in the above manner is reversed. More particularly, polarization on parts of the substrate 101 on which the comb-teeth electrode 105 is formed is reversed by application of a voltage between the frame electrode 106 and the back-face electrode 104. After that, as shown in FIG. 1D, the comb-teeth electrode 105, the frame electrode 106, the inter-electrode wire 107, the back-face electrode 104, and the insulating layer 102 are removed by using an acid solvent. A first region of the substrate 101 from which the comb-teeth electrode 105 and the frame electrode 106 are removed is called a domain inverted region 201. In the domain inverted region 201, the polarization is reversed by the application of the voltage. A second region of the substrate 101 that is not in contact with the comb-teeth electrode 105 and the frame electrode 106 is called a domain non-inverted region 202. In this manner, the periodically-poled structure where the domain inverted region 201 and the domain non-inverted region 202 are arranged alternately is formed. The pitch of the domain inverted region 201 can be adjusted appropriately by adjusting the pitch a and the width b.

The polarization reversal occurs when material-specific electric field is applied. In other words, the intensity of the electric field at which the polarization reversal occurs (hereinafter, “polarization-reversal intensity”) is unique to the material. For example, the polarization-reversal intensity of LiNbO₃ is about 20 kV/mm at the room temperature. Therefore, in the first embodiment where the 0.5 mm-thick LiNbO₃ substrate is used as the substrate 101, the polarization reversal occurs when a voltage of about 10 kV is applied. If an electric field of 40 kV/mm, which is twice as high as the polarization-reversal intensity of LiNbO₃, is applied by applying a voltage of 20 kV, the polarization reversal occurs even on a region outside the electrode pattern, which results in forming of a non-uniform and low-precision periodically-poled structure. In other words, the applied electric field is preferably close to the polarization-reversal intensity of the material used for the substrate, and be uniform within the substrate.

After the formation of the periodically-poled structure, an unnecessary region stretching along an outer circumference of the substrate 101 is cut off by using a dicing saw or the like. A facet of the substrate 101 is then optically polished. Thus, a wavelength converter element 110 having the uniform and high-precision periodically-poled structure as shown in FIG. 1E is fabricated.

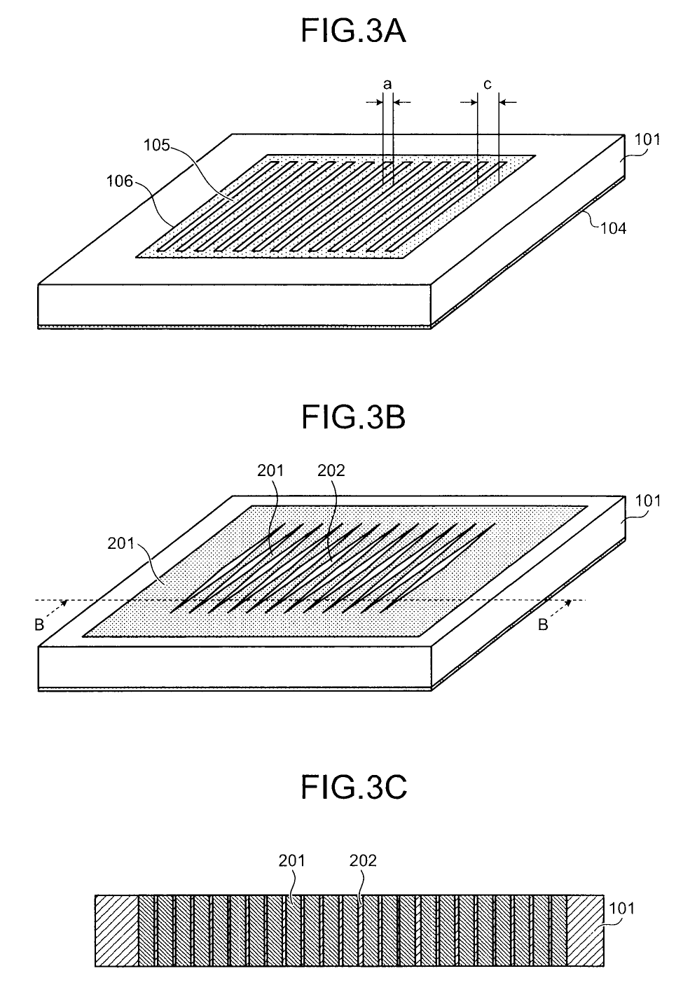

A comparison of the periodically-poled structure formed in the first embodiment and a conventional periodically-poled structure will be made here. FIG. 3A is a perspective view of an arrangement of electrodes on the substrate 101 in the course of formation of the conventional periodically-poled structure. FIG. 3B is a perspective view of the substrate 101 from which the electrodes shown in FIG. 3A are removed after the polarization is reversed by applying the voltage to the substrate. FIG. 3C is a cross-sectional view of the substrate 101 taken along a B-B line shown in FIG. 3B.

The conventional fabricating process includes following steps. That is, as shown in FIG. 3A, the comb-teeth electrode 105 and the frame electrode 106 are formed on one major surface of the substrate 101. The width of the frame electrode 106 is equal to or wider than the width of the comb-teeth electrode 105. The back-face electrode 104 is formed on the other major surface, which is opposite to the one major surface, of the substrate 101. After that, the polarization of the region on which the comb-teeth electrode 105 is formed is reversed by applying the voltage between the frame electrode 106 and the back-face electrode 104. When the voltage is applied between the frame electrode 106 and the back-face electrode 104, the polarization reversal occurs on the pattern of the frame electrode 106 and the comb-teeth electrode 105. The domain inverted region on the frame electrode 106 expands rapidly because of concentration of the electric field due to the fringe effects. The domain inverted region expands to even between the comb-teeth members. As a result, as shown in FIGS. 3B and 3C, a ratio of the width of the domain inverted region 201 to the width of the domain non-inverted region 202 is not 50:50 near the frame electrode 106, while the ratio near the center area is 50:50.

In contrast, in the process of forming the inter-electrode wire 107 that connects the comb-teeth electrode 105 to the frame electrode 106 according to the first embodiment, the inter-electrode wire 107 is formed not directly on the substrate 101 but on the insulating layer 102. As a result, the region of the inter-electrode wire 107 works as a stopper to stop expansion of the domain inverted region, and thus the domain inverted region originally on the frame electrode 106 cannot expand to between the comb-teeth members. As a result, even near tips of the elongated comb-teeth members of the comb-teeth electrode 105, the pattern of the domain inverted region is formed in as precise manner as the pattern near a center area of the comb-teeth electrode 105.

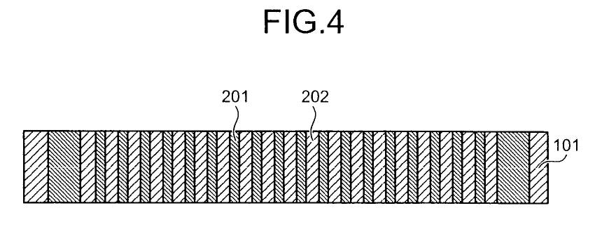

FIG. 4 is a cross-sectional view of the substrate 101 taken along a C-C line shown in FIG. 1D near the end area of the comb-teeth electrode 105. As shown in FIG. 4, the ratio of the width of the domain inverted region 201 to the width of the domain non-inverted region 202 is 50:50 even in the end area of the comb-teeth electrode 105. In other words, the excess reversal, which occurs at the end area of the conventional comb-teeth electrode, does not occur in the first embodiment. Thus, a high-precision and uniform periodically-poled structure is formed.

An area where the fringe effects can occur is described below. According to a study by inventors of the present application, the ratio of the electric-field intensity on the end area to the electric-field intensity on the center area of the comb-teeth electrode 105 should be 130% or lower to suppress the rapid expansion of the domain inverted region. To achieve the electric-field intensity ratio of 130% or lower, the width c of the frame electrode 106 is needed to be one-third of the substrate thickness or wider, regardless of what is the pitch a and the width b of the comb-teeth electrode 105.

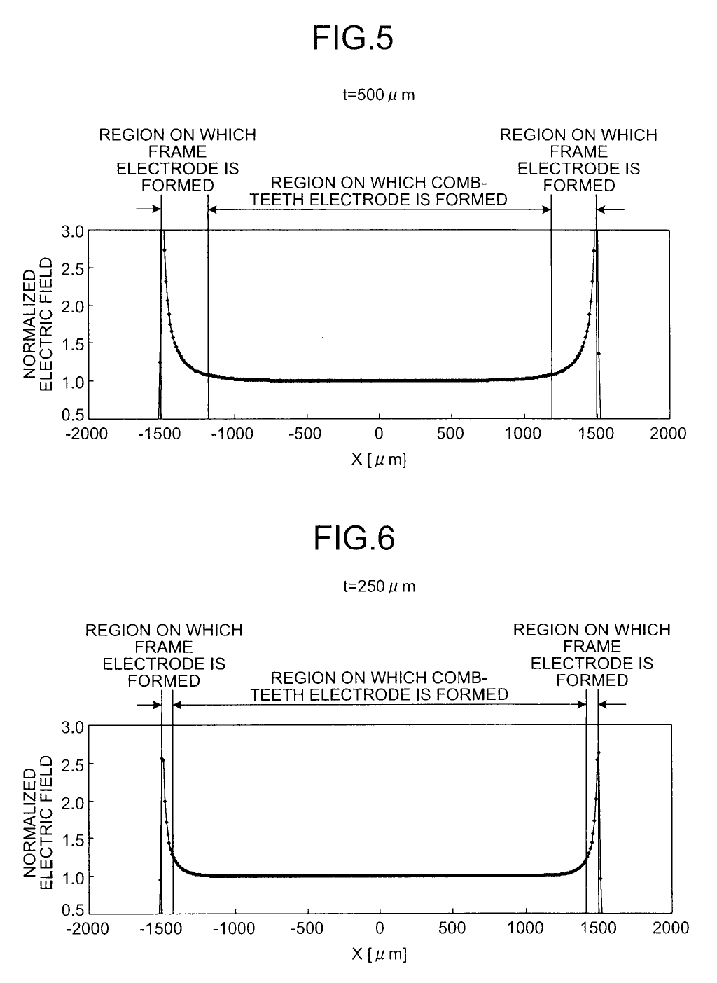

FIG. 5 is a graph of electric-field intensity when the voltage is applied for the polarization reversal in the process of fabricating the optical functional element according to the first embodiment. The horizontal axis is position X [μm] from the center point on a cross section of the substrate 101 that is perpendicular to the longitudinal axis of the comb-teeth electrode 105, where X=0 indicates the center point. The vertical axis is normalized electric-field intensity, where the intensity is normalized with respect to the point where X=0. In the graph, the electric-field intensity in two zones where −1500 μm≦X≦−1200 μm and where 1200 μm≦X≦1500 μm is the electric-field intensity in the region on which the frame electrode 106 is formed at the depth of 5 μm. The electric-field intensity in the other zone where −1200 μm<X<1200 μm is the electric-field intensity in the region on which the comb-teeth electrode 105 is formed at the depth of 5 μm.

It is clear from FIG. 5 that the electric-field intensity near the end area, i.e., near X=±1500 μm is several times as high as the electric-field intensity near the center area, because of the concentration of the electric field. The electric-field intensity is remarkably drops as one goes away from the end area. The electric-field intensity within the region of −1200 μm<X<1200 μm on which the comb-teeth electrode 105 is formed drops to about 110% against the electric-field intensity at the center point. This means that rapid expansion of the domain inverted region is suppressed, which makes it possible to fabricate the high-precision periodically-polled optical element.

If, for example, the substrate thickness is 0.5 mm, then the width c of the frame electrode 106 is needed to 0.167 mm or wider. An increase of the width of the frame electrode 106 is effective from the viewpoint of an increase of a probing area. However, the increase of the width of the frame electrode 106 causes a decrease of an effective use area per substrate, which increases the fabrication costs. According to the study by the inventors of the present application, even if the width of the frame electrode 106 is the substrate thickness or thinner, the same effects can be obtained regardless of the material of the substrate and the shape of the electrodes. As shown in FIG. 5, the electric-field intensity at X=±1000 μm is substantially equal to that at the center area. This means that a point away from the end of the electrode by the distance same as the substrate thickness, i.e., 500 μm is out of an area that is subjected to the influence of the concentration of the electric field caused by the fringe effects.

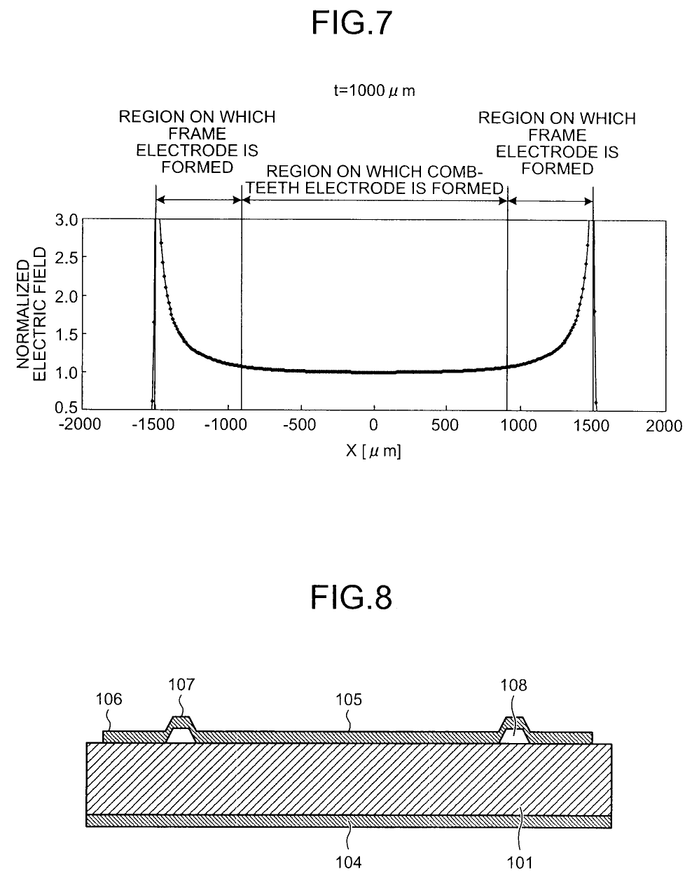

The relation between substrate thickness and distribution of the electric-field intensity is described with reference to FIGS. 6 and 7. FIG. 6 is a graph of electric-field intensity when the voltage is applied for the polarization reversal to a substrate having the thickness of 250 μm. FIG. 7 is a graph of electric-field intensity when the voltage is applied for the polarization reversal to a substrate having the thickness of 1000 μm. If the substrate thickness is 250 μm as shown in FIG. 6, the normalized electric-field intensity drops to 130% at X=±1430 μm, i.e., a point away from the end of the electrode by 70 μm. Therefore, if the comb-teeth electrode 105 is formed on the region of −1430 μm<X<1430 μm by setting the width of the frame electrode to one-third of the substrate thickness (i.e., 250 μm/3=83.3 μm), the ratio of the electric-field intensity at the end area of the comb-teeth electrode 105 to the electric-field intensity at the center area is suppressed to 130% or lower. If the width of the frame electrode is set to 250 μm, i.e., the same as the substrate thickness, the ratio of the electric-field intensity at the end area to that at the center area drops to as low as 101%.

If the substrate thickness is 1000 μm as shown in FIG. 7, the normalized electric-field intensity drops to 130% at X=±1240 μm, i.e., a point away from the end of the electrode by 260 μm. Therefore, if the comb-teeth electrode 105 is formed on the region of −1240 μm<X<1240 μm by setting the width of the frame electrode to one-third of the substrate thickness (i.e., 1000 μm/3=333.3 μm), the ratio of the electric-field intensity at the end area of the comb-teeth electrode 105 to the electric-field intensity at the center area is suppressed to 130% or lower. If the width of the frame electrode is set to 1000 μm, i.e., the same as the substrate thickness, the ratio of the electric-field intensity at the end area to that at the center area drops to as low as 101%.

However, it is not preferable to set the width of the frame electrode to a value equal to or larger than the substrate thickness from the viewpoint of the decrease of the effective use area per substrate. In other words, the optimal width c of the frame electrode 106 depends on the substrate thickness, more particularly, is preferably from one-third of the substrate thickness to equal to the substrate thickness.

It is assumed, in the first embodiment, that the width c of the frame electrode 106 is set to 300 μm, i.e., wider than one-third of the substrate thickness. Therefore, the high electric-field area due to the fringe effects is laid within the region of the frame electrode 106. In other words, the excess reversal does not occur on the end area of the comb-teeth electrode 105.

Moreover, the length d of the inter-electrode wire 107 is set to a value that is equal to or longer than one-half of the pitch a of the comb-teeth electrode 105, i.e., wider than a gap between adjacent ones of the comb-teeth members of the comb-teeth electrode 105. Therefore, even if the excess reversal occurs locally, the domain inverted region formed on the frame electrode 106 is not joined with the domain inverted region formed on the comb-teeth electrode 105 before the domain inverted regions on the adjacent comb-teeth members are joined with each other. Thus, the method of fabricating the stable optical function element is provided.

In the first embodiment, occurrence of the excess reversal due to the fringe effects on the end area of the comb-teeth electrode 105 is suppressed as compared to the conventional process. Thus, it is possible to provide the method of fabricating the optical functional element having the uniform and high-precision periodically-poled structure with a high yield ratio.

Moreover, if a wavelength convertor element having the periodically-poled structure that is formed by using this fabricating method is used as the optical functional element, higher wavelength conversion efficiency is obtained because of the high-precise periodically-poled structure. The increase of the wavelength conversion efficiency makes it possible to decrease a power of a laser light that is input to the wavelength convertor element, which results in suppressing energy consumption for emitting the laser light. The decrease of the energy consumption results in a decrease of undesired heat generation, which makes it possible to downsize a cooling mechanism of the optical functional element.

In the first embodiment, the photoresist material such as the novolak-based positive resist is used as the insulating layer. In a second embodiment of the present invention, an inorganic material, such as a silicon dioxide film and a silicon nitride film, is used as the insulating layer 102.

Because the insulating layer (sacrificial layer) 102 is made of the photoresist in the first embodiment, there is possibility of occurrence of insulation breakdown when the voltage is applied and occurrence of unintentional polarization reversal by an undesired leak current. To solve the problem, an inorganic material such as a silicon dioxide film or the like is used as the insulating layer 102 in the second embodiment.

A method of fabricating an optical functional element according to the second embodiment is almost the same as the fabricating process according to the first embodiment except how the insulating layer 102 is formed. The same description is not repeated from the viewpoint of simplicity. In the patterning of the insulating layer 102, the resist mask is formed on the insulating layer 102 and the insulating layer 102 is etched with CF₄ plasma or the like.

In the second embodiment, it is possible to obtain, in addition to the effects in the first embodiment, a higher degree of freedom in designing, because high-temperature processing is available. Because the insulating layer is made of the resin material such as the photoresist in the first embodiment, the electric insulating property and the withstand voltage is not high enough. That is, there is possibility of occurrence of the undesired polarization reversal and the insulation breakdown when the high voltage is applied for the polarization reversal. In the second embodiment, reliability in the fabricating process is improved by the use of the inorganic material such as the silicon dioxide film or the silicon nitride film as the insulating layer 102. It is preferable to form the insulating layer with a material that is easy to fabricate and has the properties similar to those of the silicon dioxide film and the silicon nitride film.

In the first embodiment and the second embodiment, the insulating layer made of a solid material such as the photoresist or the silicon dioxide film is formed under the inter-electrode wire. In the third embodiment, an air layer 108 is formed as the insulating layer under the inter-electrode wire 107 instead of the solid insulating layer 102.

A method of fabricating an optical functional element according to the third embodiment is almost the same as the fabricating process according to the first embodiment except how the insulating layer 102 is formed. The same description is not repeated from the viewpoint of simplicity. In the third embodiment, the resist of the insulating layer 102 is post-baked at a lower temperature for a shorter period, as compared to the post-baking in the first embodiment. Assume, for example, the resist is post-baked at 120° C. for three hours. Moreover, in the electrode patterning, the resist mask that is used for etching of the metal layer 103 and the resist of the insulating layer 102 are removed with a solvent such as an acetone solvent at the same time.

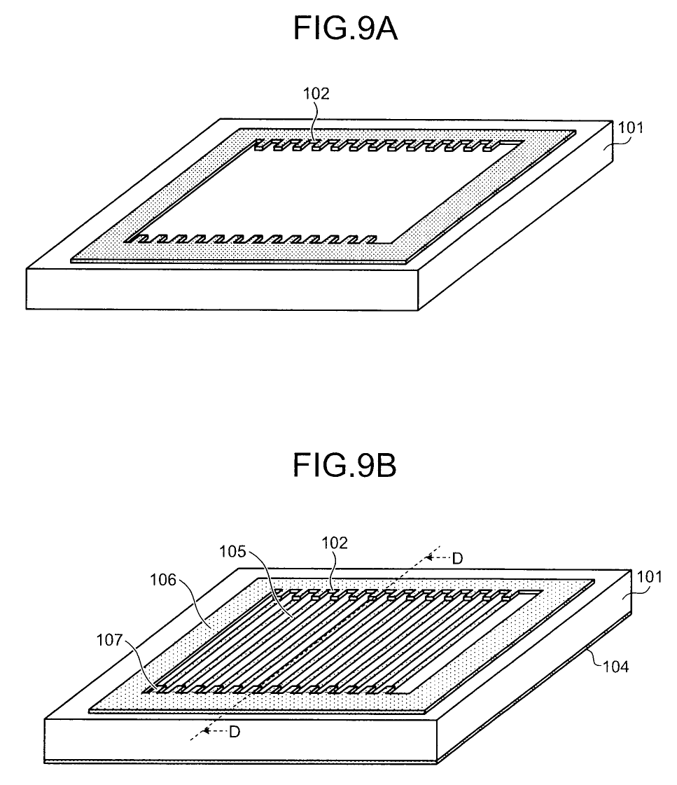

FIG. 8 is a cross-sectional view of the substrate 101 after the electrodes are patterned according to the third embodiment. The cross-sectional view of FIG. 8 is equivalent to the cross-sectional view of FIG. 1C taken along the A-A line. As shown in FIG. 8, the air layer 108 is formed under the inter-electrode wire 107 (i.e., between the inter-electrode wire 107 and the substrate 101).

In the third embodiment, because the insulating property and the withstand voltage of the air layer 108 is superior to those of the insulating layer 102, it is possible to obtain, in addition to the effects in the first embodiment, an effect of further suppressing occurrence of the unintentional polarization reversal and the insulation breakdown when the high voltage is applied for the polarization reversal.

In the first embodiment to the third embodiment, the frame electrode is in direct contact with the substrate. However, in a fourth embodiment of the present invention, the frame electrode 106 is not in direct contact with the substrate 101. This structure is effective to stop progress of the polarization reversal under the frame electrode 106 when the high electric field is applied.

In the first embodiment, the length d of the inter-electrode wire 107 is set equal to or longer than one-half of the pitch a of the comb-teeth electrode 105 so that the frame electrode 106 and the comb-teeth electrode 105 are spaced enough to prevent joining of the domain inverted region on the frame electrode 106 with the domain inverted region on the comb-teeth electrode 105 due to the excess reversal. In some cases, nevertheless, the domain inverted region on the frame electrode 106 joins accidentally and locally with the domain inverted region on the comb-teeth electrode 105 due to the excess reversal. In the fourth embodiment, the insulating layer is formed under the frame electrode 106 so that the polarization reversal cannot occur under the frame electrode 106.

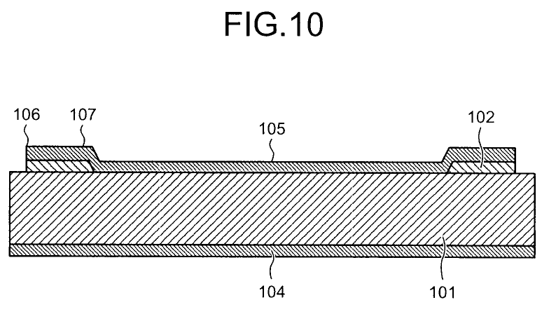

FIGS. 9A and 9B are perspective views of different states of the substrate 101 in the course of formation of the electrode pattern by using a method of fabricating an optical functional element according to the fourth embodiment. FIG. 10 is a cross-sectional view of the substrate 101 taken along a D-D line shown in FIG. 9B. In the fabricating method according to the fourth embodiment, the insulating layer 102 is patterned by photolithography, with a mask pattern different from the mask pattern that is used in the first embodiment, to cover an entire area on which the frame electrode 106 is formed in addition to the region on which the inter-electrode wire 107 is formed. After that, the comb-teeth electrode 105 with the predetermined pitch is formed on a region surrounded by the insulating layer 102. The frame electrode 106 is formed on the insulating layer 102. The other steps of the fabricating process according to the fourth embodiment are substantially the same as those of the fabricating process according to the first embodiment, and the same description is not repeated from the viewpoint of simplicity.

In the fourth embodiment, it is possible to obtain, in addition to the effects in the first embodiment, a higher degree of freedom in designing, because there is no need to take into consideration the joining between the domain inverted region on the frame electrode 106 and the domain inverted region on the comb-teeth electrode 105. This makes it possible to increase the yield ratio.

According to an aspect of the present invention, it is possible to arrange a comb-teeth electrode outside a high electric-field region occurring due to fringe effects and thus prevent occurrence of polarization reversal under an inter-electrode wire. Therefore, excess reversal does not occur on an end area of the comb-teeth electrode. This makes it possible to form a uniform and high-precise periodically-poled structure.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of fabricating an optical functional element comprising:
forming, on a first major surface of a substrate made of a ferroelectric material, a comb-teeth electrode including a plurality of elongated comb-teeth members, a frame electrode surrounding the comb-teeth electrode, an inter-electrode wire that connects the comb-teeth electrode to the frame electrode, the comb-teeth members being parallel to each other at a predetermined pitch;
forming, on a second major surface of the substrate that is opposite to the first major surface, a back-face electrode to cover an entire area of the second major surface;
forming a periodically-poled structure by applying a voltage between the frame electrode and the back-face electrode; and
cutting out a region equivalent to the periodically-poled structure from the substrate, thereby fabricating the optical functional element, wherein
the inter-electrode wire is formed on an insulating layer that is formed on the substrate.

2. The method according to claim 1, wherein a width of the frame electrode is from one-third of a thickness of the substrate to equal to the thickness of the substrate.

3. The method according to claim 1, wherein a length of the inter-electrode wire is equal to or longer than one-half of a pitch of the comb-teeth electrode.

4. The method according to claim 1, wherein the insulating layer is made of a solid material.

5. The method according to claim 4, wherein the insulating layer is made of any one of resin, silicon oxide, and silicon nitride.

6. The method according to claim 1, wherein the insulating layer is air.

7. The method according to claim 1, wherein both the inter-electrode wire and the frame electrode are formed on the insulating layer.
